(19) United States
(12) Patent Application Publication
(10) Pub. No.: US 2006/0059451 A1
(43) Pub. Date: Mar. 16, 2006

(54) Method for creating and synthesizing multiple instances of a component from a single logical model

(75) Inventors: Brian L. Koehler, Rochester, MN (US); Robert A. Shearer, Rochester, MN (US); Lance G. Thompson, Rochester, MN (US)

Correspondence Address: Robert R. Williams;IBM Corporation, Dept. 917, 3605 Highway 52 North, Rochester, MN, 55901-7829, US

(73) Assignee: International Business Machines Corporation, Armonk, NY (US)

(21) Appl. No.: 10/941,415

(22) Filed: Sep. 15, 2004

(51) Int. Cl. G06F 17/50

(52) U.S. Cl. 716/17; 716/3

(57) ABSTRACT

Methods for creating and synthesizing multiple instances of a component from a single logical model are provided. In general, a flag is provided which designates a design methodology for use in instantiating the component. Depending on the value of the flag, a block of hardware design code defining an instance of the component according to a design methodology is loaded.

### BACKGROUND OF THE INVENTION

1. Field of the Invention

The present invention generally relates to a method for creating a VLSI chip design, and more specifically a method for creating a single logical model for a component that may be used to fabricate different variations of the component according to multiple design requirements and methodologies.

2. Description of the Related Art

Current computer systems typically contain several integrated circuit (IC) devices, each device being designed to perform a separate function within the system. Each device may perform a different function such as general data processing or graphics processing. Each device typically contains within it several components having sub-components, each of which are delegated some portion of the device's function. The devices typically share data and processing results with each other across a system bus.

Designers of integrated circuit devices generally use hardware description languages, such as VHDL (Very High Speed Integrated Circuit Hardware Description Language), to capture the design of a device and components within a device. The designer of a component typically uses a hardware description language to create a logical model of the component. The logical model typically contains hardware design code which may be used to define an instance the component. The hardware design code for the component may be used by a compiler to compile an instance of the component. The hardware design code may also be used by a synthesis tool to synthesize an instance of the component.

Each device within a computer system may be designed according to a different design methodology. The design methodology of a device refers to the manner in which the device is described and implemented by a designer. For example, the design methodology for a device may be a structural design methodology (also referred to as a custom design methodology) which uses a physical description of the hardware components and interconnections of components on a device to describe the device. The design methodology may also be a behavioral design methodology (also referred to as an Application-Specific Integrated Circuit (ASIC) design methodology) which uses a description of how each component functions in terms of input and output signals to describe a device.

Each design methodology may differ in the amount of effort spent in designing the device, the style of describing the device, the sets of signals used by the device, the amount of testing hardware included in the device, and other facets which determine how the device will function, such as component dimensions. Because the design methodology may be different for each device, the hardware design code for each device may be different according to the design methodology.

While each of the devices in a system may be designed according to different design methodologies and may contain components that perform different functions, each device may require a component that performs an identical function for each device, and is thus designed according to a single logical model for each device. For instance, each device may contain a component which serves as a bus interface. The bus interface on each of the devices in a system typically performs identical functions for each device, allowing the devices to communicate with each other. The identical functions may include sending and receiving data at the same clock speed, at the same voltage level, and with the same control signals as every other bus interface. However, the bus interface of each device may also have requirements specific to their corresponding device (e.g. due to different internal bus speeds, bus widths, power requirements, etc.).

While a component may have a single logical model for several devices, the designer may have the task of creating hardware design code for the component according to different design methodologies for each of the devices. Ideally, the designer may prefer that the logical model of the component accommodate each design methodology and each corresponding block of hardware design code. The logical model could be used to compile and synthesize each instance of the component while insuring that the component will function identically on each device. Such a model may also allow the designer to ensure that a change in one block of hardware design code was made to each corresponding block of hardware design code according to each of the other design methodologies. Unfortunately, such a model does not currently exist, and thus, designers must create separate logical models to create components according to different design methodologies.

Accordingly, what is needed is a method for creating a single logical model of a component that facilitates creating components according to different design methodologies. During synthesis, resulting instances of the component may then be defined by different blocks of hardware design code corresponding to the different design methodologies.

### SUMMARY OF THE INVENTION

The present invention provides a method for creating multiple instances of a component wherein a specific design methodology used for each instance is different. The method comprises providing a logical model for the component, the logical model having a flag having two or more possible values and specifying for each value of the flag one or more blocks of hardware design code defining an instance of the component in accordance with a corresponding design methodology. To provide a greater degree of flexibility in design, the flag may be set to different values at different component and/or subcomponent levels. Thus, different components of the same device may be created according to different design methodologies.

One embodiment of the invention provides a method for creating multiple instances of a component from a single logical model. The method generally includes providing a flag in the logical model which designates a design methodology for use in instantiating the component. The method also includes setting the flag to a first value to load a first block of hardware design code where the hardware design code defines a first instance of the component and corresponds to a first design methodology, and setting the flag to a second value to load a second block of hardware design code where the hardware design code defines a second instance of the component and corresponds to a second design methodology.

Another embodiment of the invention provides a system and a computer readable medium containing a program for processing multiple instances of a component wherein a specific design methodology used for each instance is different. The program, when executed, loads a logical model for the component, the logical model having a flag having two or more possible values. The program determines a value of the flag and processes, based on the value of the flag, one or more blocks of hardware design code defining an instance of the component in accordance with a corresponding design methodology.

### BRIEF DESCRIPTION OF THE DRAWINGS

So that the manner in which the above recited features, advantages and objects of the present invention are attained and may be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating an exemplary computer system, components of which may be designed in accordance with embodiments of the present invention;

FIG. 2 is a block diagram illustrating a logical model of a component defining two instances of the component according to one embodiment of the invention;

FIG. 3 is a block diagram illustrating a logical model of a front side bus interface according to one embodiment of the invention;

FIG. 4 is a block diagram illustrating an instance of a front side bus interface according to one embodiment of the invention;

FIG. 5 is a block diagram illustrating another instance of a front side bus interface according to one embodiment of the invention; and

FIG. 6 is a flow diagram illustrating a method for synthesizing an instance of a component defined by a logical model according to one embodiment of the invention.

### DETAILED DESCRIPTION OF THE PREFERRED EMBODIMENTS

Embodiments of the present invention provide a method for creating multiple instances of a component from a single logical model. In general, a flag is provided which designates a design methodology for use in instantiating the component. Depending on the value of the flag, a different block of hardware design code defining an instance of the component according to one of mutliple design methodologies is loaded. Accordingly, designers may be able to concurrently create two instances of a component, each instance requiring different design concerns and having a different physical embodiment while having the same overall function as the other instances. Such a design method may speed up the overall design process, shorten time to market, reduce overall cost, reduce design errors, and simplify testing and verification of the designs.

To facilitate understanding, embodiments will be described with respect to a front side bus (FSB) interface being designed according to a structural and behavioral design methodology for use with a central processing unit (CPU) and graphical processing unit (GPU) within a computer system as a specific, but not limiting, application example. However, the aspects described herein may be generally applied to the design of any component using multiple design methodologies for use on multiple hardware devices in the same system or for devices in different systems.

Also, embodiments below will be described with respect to two design methodologies, a structural design methodology and a behavioral design methodology. However, the invention may be applied using more than two design methodologies, and using design methodologies other than structural or behavioral methodologies. Accordingly, while the flag variable used to select the design methodology is discussed below as being a binary (having two possible values) variable, where more than two design methodologies will be used, the flag variable may allow for multiple values according to the number of design methodologies being employed.

### An Exemplary System

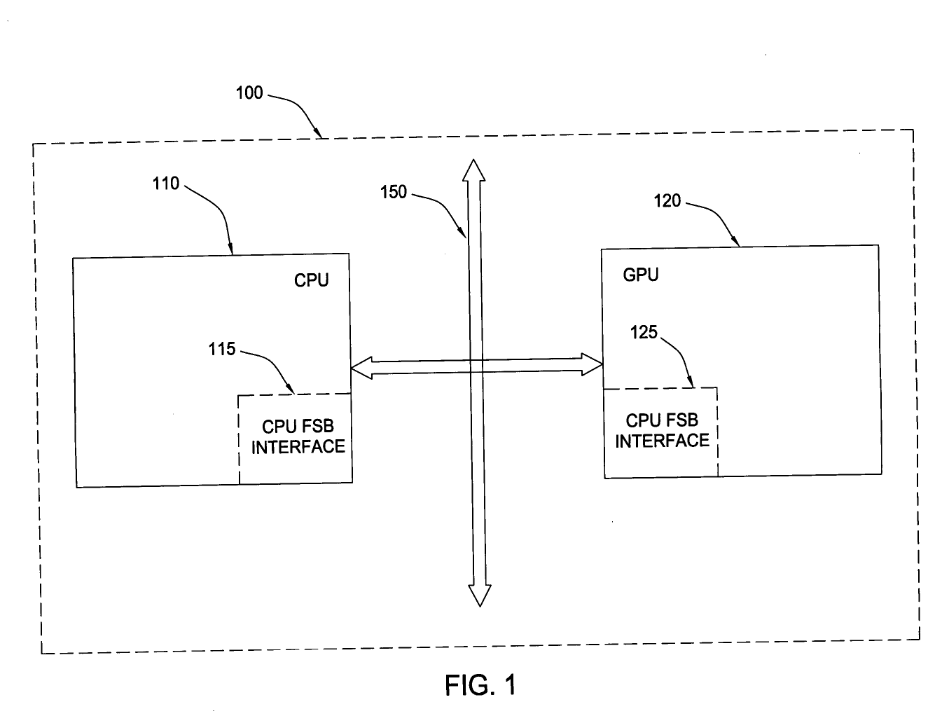

One embodiment of the invention is implemented as a method for creating multiple instances of a component from a single logical model where each instance of the component will be used in a computer system such as the computer system 100 shown in FIG. 1. As illustrated, the computer system 100 may contain a CPU 110 and a GPU 120. The CPU 110 typically performs general data processing whereas the GPU 120 typically performs specialized graphics processing. Each of the processing units 110, 120 may be in communication with each other across a front side bus (FSB) 150. To communicate across the FSB 150, the CPU 110 typically has an FSB interface 115 and the GPU 120 has a corresponding FSB interface 125.

The CPU 110 and GPU 120 for a system may be designed by different design teams. Design of each device by different design teams typically allows each design team to specialize in the specific design requirements for each device, the requirements being different with respect to use of chip space, power consumption, relative speed, and so on. The design teams may even work for different companies located remotely from each other. Each company may specialize in the design of a certain type of component such as a CPU or a GPU. Each company may also use different foundries and thus different manufacturing processes to manufacture the devices. For these reasons, each design team may design each device according to a different design methodology.

As an example, the CPU 110 may be designed using a structural design methodology (also referred to as the custom design methodology). A structural design methodology uses structural design code to describe the physical components and connections between components which will be used by the CPU 110. The smallest components, such as latches, may be contained in hardware libraries. Hardware libraries are files which typically contain structural descriptions of physical components. The structural description may include a description of the signals used by the component, the connections on the component, the size and physical layout of the component, and other factors describing the physical nature of the component such as bus widths and signal strengths used by the component. A physical component may be inserted from a hardware library by placing a reference to the library and the component in the hardware design code wherever that component will appear. Larger components may use the smaller physical components as subcomponents, creating several layers of components in the design.

The structural design methodology typically requires greater design effort because every physical component and subcomponent must be described by the designer. However, the structurally designed component typically uses chip space more efficiently, may run faster, and/or consume less power because the resulting design has been more carefully developed. The structural design methodology may be chosen for use in designing the CPU 110 because the CPU 110 may have more components on a single chip than other devices, thus requiring selection of a design methodology (such as the structural design methodology) which results in an instance of the component that may be more compact than instances of the component created according to other design methodologies (such as the behavioral methodology).

The GPU 120, on the other hand, may be designed using a behavioral design methodology (also referred to as the Application-Specific Integrated Circuit (ASIC) design methodology). A behavioral design methodology uses behavioral design code to describe the behavior of each component in a device. Thus, the description of a component using a behavioral design methodology may describe what function the component performs as opposed to physically defining the component. A behavioral description may be used for the smallest components on a device. Larger components may also use the smaller behaviorally designed components as subcomponents, creating several layers of components in the design.

The behavioral design methodology requires less design effort because describing the function of a component requires less effort than describing the physical hardware necessary to perform that function. Because less design effort is required, the behavioral methodology may be used to speed up the design schedule of a component. However, the behaviorally designed component typically uses more chip space and may run slower than a structurally designed component. The behavioral design methodology may be chosen for use in designing the GPU 120 because the GPU 120 may have fewer components on a single chip than other devices, thus allowing selection of a design methodology (such as the behavioral design methodology) which may allow for an expedited design schedule while resulting in an instance of the component that may occupy more chip space compared to instances designed according to other design methodologies (such as the structural methodology).

While the CPU 110 and GPU 120 typically perform different functions within the computer system, each FSB interface 115, 125 typically performs the same function, allowing the CPU 110 and GPU 120 to communicate with each other across the FSB 150. Identical functioning of the FSB interfaces 115, 125 is necessary to ensure that each device 110, 120 sends data at the same transfer rate and using the same control signals. If the transfer rates or control signals are not identical, data may be lost during transmission and communication may be impossible between each of the devices 110, 120.

In some cases, the FSB interfaces 115, 125 may be designed by a separate design team(s) other than the design team for other components of the CPU 110 and the GPU 120. Having an FSB interface design team that designs the FSB interfaces 115, 125 for each device 110, 120 allows the CPU design team and GPU design team to concentrate on design of other components of the CPU 110 and GPU 120 without being burdened by the details of the FSB interface design. The design team for the FSB interfaces 115, 125 may face three major tasks. First, the design team must create two logical models of the component containing two sets of design code defining two instances of the component. One instance of the component must be defined for the CPU design methodology and one instance must be defined for the GPU design methodology. Second, the design team must test each logical model of the component separately to ensure that the logical model of each instance of the FSB interface functions correctly. Finally, the designer must ensure that each logical model performs the same as the other logical model, insuring that CPU FSB interface 115 will be able to communicate with the GPU FSB interface 125. Also, if the designer makes a functional change to the hardware design code for one logical model, the designer must find the corresponding area of hardware design code in the other logical model and make a corresponding change to ensure that both models function identically.

### An Exemplary Logical Model

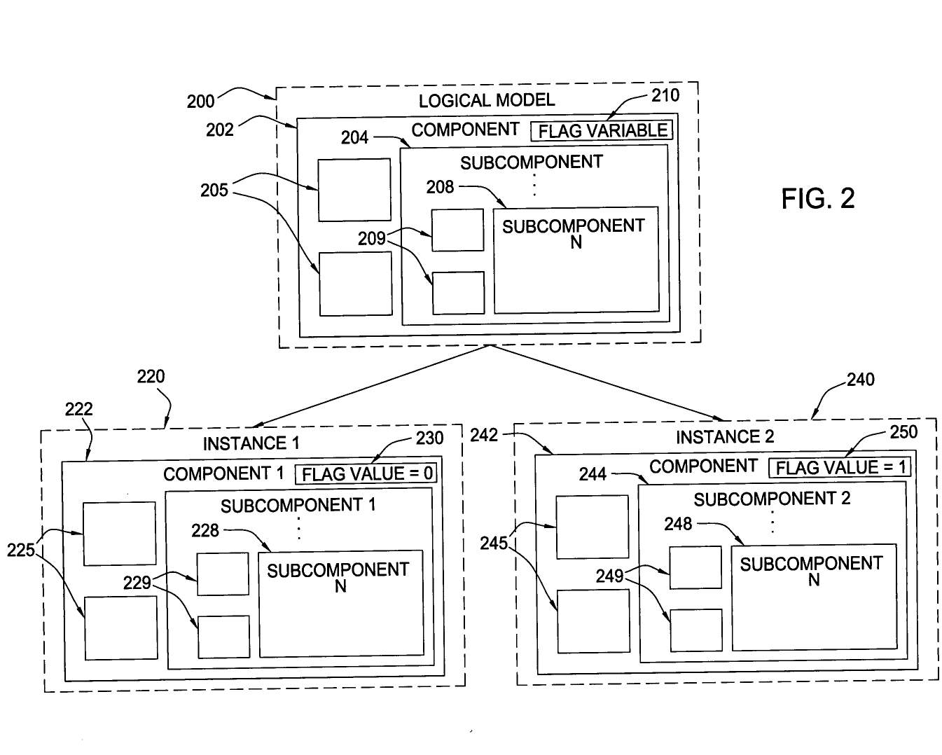

Embodiments of the present invention simplify the task of a design team by allowing the team to create a single logical model 200 of a component 202 which defines two instance 220, 240 of the component 202, as shown in FIG. 2. The logical model of the component 202 may contain a layer having a first subcomponent 204 as well as other subcomponents 205. The first subcomponent 204 (as well as the other subcomponents 205) may contain layers with further subcomponents 208, 209.

The logical model 200 may be used by the design team to define two instances 220, 240 of the component 202 according to each of the design methodologies for the devices. The design team separates each instance 220, 240 within the logical model 200 using a flag variable 210. By setting the flag variable 210 to a first value 230, the design team may load a first block of hardware design code corresponding to the first instance 220. The first instance 220 will have hardware design code defining an instance of the component 222 containing a first layer of subcomponents 224, 225 and further layers of subcomponents 228, 229. The first block of hardware design code may contain a structural description of the instance and may correspond to a structural design methodology. By setting the flag variable 210 to a second value 250, the design team may load a second block of hardware design code corresponding to the second instance 240. The second instance 240 will have hardware design code defining an instance of the component 242 containing a first layer of subcomponents 244, 245 and further layers of subcomponents 248, 249. The second block of hardware design code may contain a behavioral description of the instance and may correspond to a behavioral design methodology.

In one contemplated embodiment of the invention, the flag variable 210 may be added as an extension to the hardware description language and may be used with a compiler and synthesis tool to compile and synthesize each instance of the component 202. In another contemplated embodiment of the invention, the flag variable 210 may be implemented by utilizing existing hardware description language features which allow the design team to add customized parameters to a component.

For instance, in VHDL, the flag variable 210 could be implemented as a generic. Generics are used in VHDL to specify parameter values for a component at the time the component is instantiated. Thus, according to one embodiment of the invention, the design team may create a generic called expand_type. The design team may then create a logical model of the desired component. When creating the logical model, the design team may specify a block of hardware design code to be loaded for each value of expand_type. Each block of hardware design code, and thus each value of expand_type, corresponds to each design methodology being used. The generic for expand_type may also be used in each layer of the logical model. Use of the generic in each layer is implemented by passing the value of expand_type from each component to each of its subcomponents and so on. Thus, when the component is instantiated according to a design methodology, each of the subcomponents of that component will also be instantiated according to that design methodology.

The following code illustrates a simplified version of the code (also known as pseudocode) which the designer may use to create the logical model of the component:

If expand_type equals 0, use the following code for the component:

. . .
( Structural design code for the component )
. . .

If expand_type equals 1, use the following code for the component:

. . .
( Behavioral design code for the component )
. . .

The pseudocode above describes the following situation: for each value of expand_type, the designer has specified hardware design code that describes the component. For first value of expand_type, the designer has specified a structural description of the component which corresponds to the design methodology for the instance of the component that will be placed on the CPU. When the expand_type is set to zero, the compiler and synthesis tool will compile and synthesize the CPU instance of the component using the structural design code. For the second value of expand_type, the designer has specified a behavioral description of the component which corresponds to the design methodology for the instance of the component that will be placed on the GPU. When the expand_type is set to one, the compiler and synthesis tool will compile and synthesize the GPU instance of the component using the behavioral design code.

So that the above pseudocode may be understood better, consider the implementation of a simple component such as a latch. A latch is a small component used to store a piece of input data whenever a clock signal is received. The following pseudocode shows a structural and a behavioral design of a latch in a single model:

If expand_type equals 0, use the following code for the latch:

Insert latch_model from hardware library
Connect latch_model to clock_signal and data_input

If expand_type equals 1, use the following code for the component:

When clock_signal is 1, store data_input

The pseudocode above describes the following situation: for the first value of expand_type, the designer has specified that the latch called latch_model should be loaded from the hardware library. When expand_type is set to zero, the compiler and synthesis tool will load latch_model from the hardware library, and connect latch_model to clock_signal and data_input. The compiler and synthesis tool will then use the structural design code for the component to compile and synthesize the structural instance of the latch component for use in the CPU 110. When expand_type is set to one, the compiler and synthesis tool will load the behavioral design code which describes the function of the latch. The compiler and synthesis tool will then use the behavioral design code for the component to compile and synthesize the behavioral instance of the latch component for use in the GPU 120. Although the behavioral code for the GPU instance of the component does not explicitly show a latch, when the GPU instance of the component is being synthesized, the synthesis tool will use the behavioral description of the latch to infer and synthesize a physical latch, such that both the CPU and GPU designs will function in the same manner.

According to one embodiment of the invention, the flag may be used for more than choosing between blocks of hardware design code corresponding to different design methodologies. For instance, if the CPU design methodology included more testing structures to test the CPU 110, expand_type could be used to include those extra testing structures in the CPU design without adding corresponding testing structures to the GPU design.

The flag may also be used to vary physical properties of the instantiated component according to the design methodology being used. For instance, if the GPU 120 had a different data bus width than the CPU 110, the GPU bus width could be set to a function of expand_type (e.g. bus_width=expand_type*3+2). Similar methods may be used to vary the signal size, array types, libraries, and clock polarities of the instantiated component according to each of the design methodologies.

In another embodiment of the invention, expand_type may be used to select between sets of signals used by each instance of the component. For instance, where the GPU instance of the FSB interface 125 has a reset signal and the CPU instance of the FSB interface 115 does not, the logical model of the component may contain the extra GPU signal. The expand type flag may then be used in the behavioral design code to implement the reset functionality in the GPU instance of the FSB interface 125 while allowing the CPU instance of the FSB interface 115 to ignore the signal. Thus, the reset behavior may be added to the GPU instance of the FSB interface 125 while being omitted from of the CPU instance of the FSB interface 115.

In another contemplated embodiment of the invention, the flag may be used to add or remove a connection on a component (referred to as a port). For instance, VHDL contains the concept of a null range, i.e. a range with no elements within it. A port may be declared with a range of “1 to expand_type”. When the CPU design methodology is chosen for synthesis, expand_type is zero, so the range becomes a null range of “1 to 0”, effectively removing the port from the CPU instance of the component. While current synthesis tools may not have the ability to recognize and implement a null range, the current synthesis tools may be easily modified to do so.

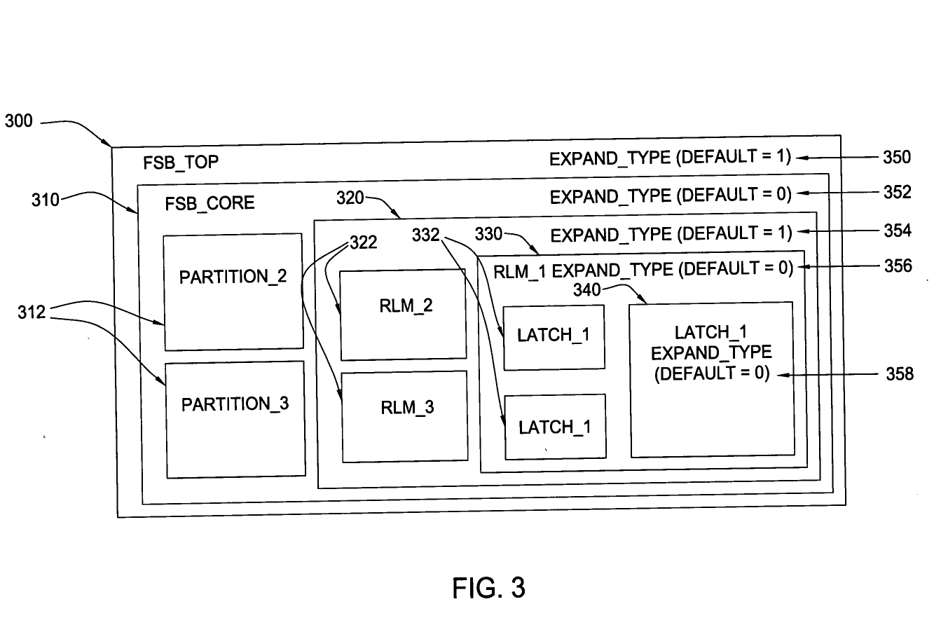

FIG. 3 illustrates a logical model of an FSB interface 300 according to one embodiment of the invention. The FSB interface 300 may contain a core 310 containing a first partition 320 as well as other partition components 312. The FSB interface 300 also contains an expand_type generic having a default value 350. The expand_type value 350 may be passed to the core 310 which has an expand_type with a default value 352. The expand_type value 352 of the core may be passed to the partitions 320, 322 each of which have contains an expand_type generic having a default value 354. The partition 320 may contain a first random logic macro (RLM) 330 as well as other RLMs 322. The expand_type value 354 of the first partition 320 may be passed to the expand_type 356 for the first RLM 330. Finally, at the lowest level of the model, the first RLM 330 may contain a first latch 340 as well as other latches 332. The expand_type value 356 for the first RLM 330 may be passed to the expand_type 358 for the first latch 340.

The default values for expand_type may be specified according to how the logical model 300 will be compiled and synthesized. The entire logical model may not be compiled and synthesized at once. Also, the logical model 300 might be compiled and synthesized beginning at different levels of components according to the design methodology. For instance, the CPU design methodology may focus on the RLM level of components during compilation and synthesis. Thus, the CPU instance of the FSB interface 115 may be compiled and synthesized at the RLM level first, ignoring the levels of components above the RLM level. Accordingly, the default value of expand_type for the RLM level of components may be set to zero 356, corresponding to the CPU design methodology.

### An Exemplary CPU Instance

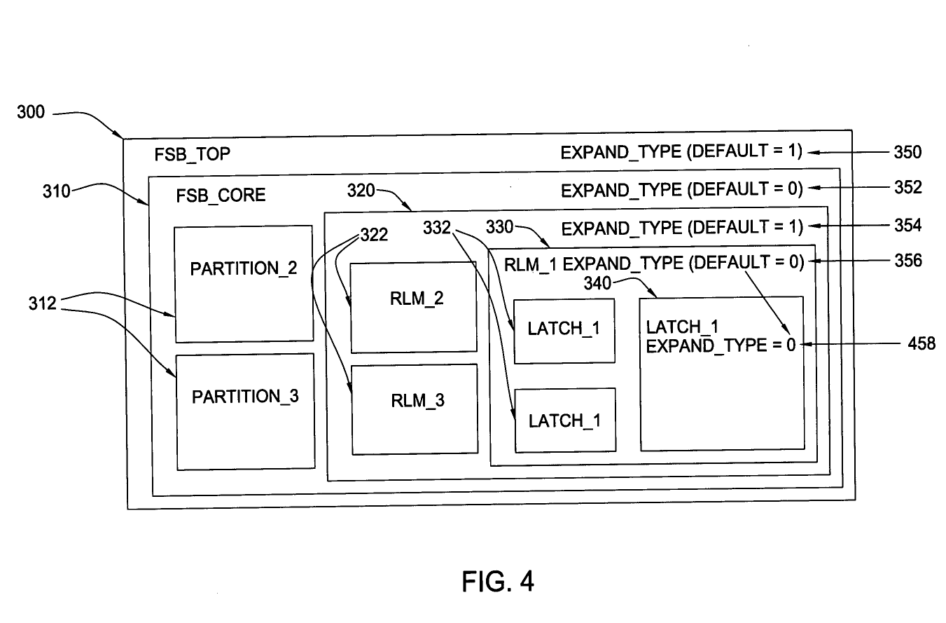

FIG. 4 illustrates the CPU instance of the FSB interface 115 as it may appear during compilation and synthesis according to one embodiment of the invention. When compilation and synthesis begins on the instances of the RLM level of components 330, 322, the default expand_type value 356 for the first instance of the RLM 330 is zero, which corresponds to the CPU design methodology. The expand_type value of zero 356 causes the compilation and synthesis tools to load the block of hardware design code corresponding to the CPU instance of the FSB interface 115. The expand_type value 356 for the RLM instance 330 may then be passed to the CPU instance of the latch 340, overriding the default value 358 with a value of zero 458. The compilation and synthesis tools may then use the expand_type value 458 to load the hardware design code for the CPU instance of the latch 340.

After the lower (RLM) levels of the design have been compiled and synthesized, the higher levels of the CPU instance of the FSB interface 115 may be compiled and synthesized. When the higher levels of the CPU instance 115 are being compiled and synthesized, the RLM components may, in effect, be treated as black boxes, allowing the higher levels of components of the CPU instance of the FSB interface 115 to be examined independently. Later, the compiled and synthesized versions of the RLMs may be inserted in place of the black boxes to complete the design.

The GPU design methodology may begin compilation and synthesis at a different level of components than the CPU design methodology. The GPU design methodology may only focus on compiling and synthesizing the GPU instance of the FSB interface 125 at the partition level of components. Thus, compilation and synthesis may begin at the partition level of the logical model when the GPU instance of the FSB interface 125 is being compiled and synthesized. Accordingly, the default value of expand_type for the partition level of components 354 may be set to one, corresponding to the GPU design methodology.

### An Exemplary GPU Instance

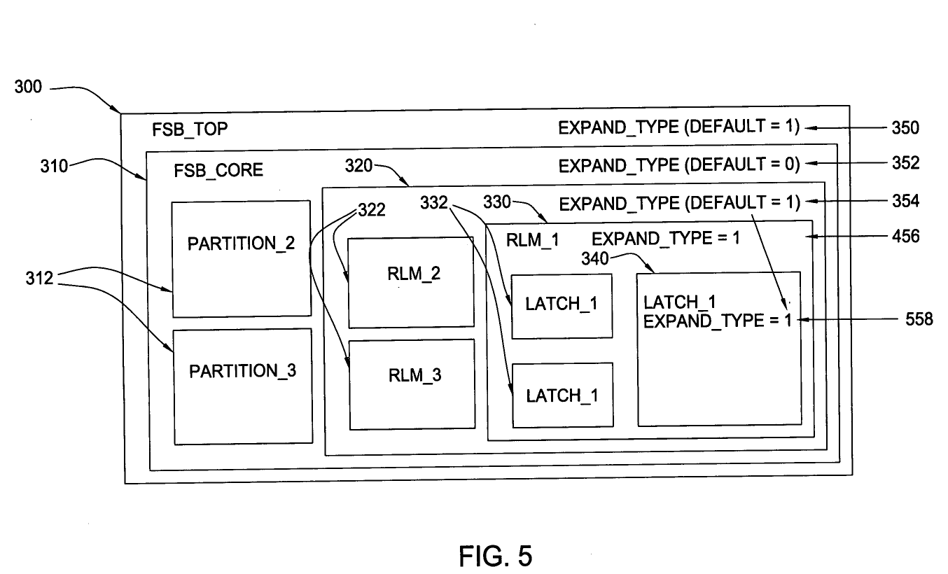

FIG. 5 illustrates the GPU instance of the FSB interface 125 as it may appear during compilation and synthesis according to one embodiment of the invention. When compilation and synthesis begins on the GPU instances of the partition level of components 320, 312, the default expand_type value 354 for the first instance of the partition 320 is one 354, which corresponds to the GPU design methodology. The expand_type value 354 causes the compilation and synthesis tools to load the block of hardware design code corresponding to the GPU instance of the FSB interface 125. The expand_type value 354 for the GPU instance of the partition 320 may then be passed to the GPU instance of the RLM 330, overriding the default value of zero 356 with a value of one 556, allowing the compilation and synthesis tools to load the hardware design code for the GPU instance of the RLM 330. The GPU instance of the RLM 330 may then pass the expand_type value 556 corresponding to the GPU design methodology to the GPU instance of the latch 340, overriding the default value of expand_type 358 with a value of one 558. The compilation and synthesis tools may then use the expand_type value 558 to load the hardware design code for the GPU instance of the latch 340.

After the lower (partition) levels of the GPU design have been compiled and synthesized, the higher levels of the GPU instance of the FSB interface 125 may be compiled and synthesized. When the higher levels of the GPU instance 125 are being compiled and synthesized, the partition components may be treated, in effect, as black boxes, allowing the higher levels of components of the GPU instance of the FSB interface 125 to be examined independently. Later, the compiled and synthesized versions of the partition components may be inserted in place of the black boxes to complete the design.

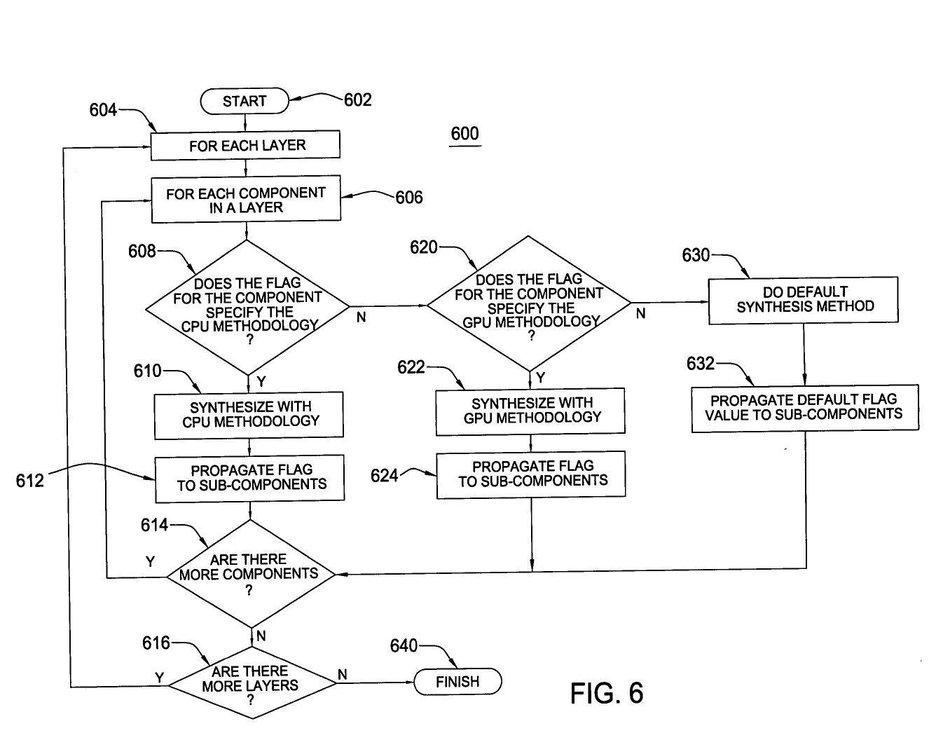

FIG. 6 is a flow diagram illustrating a method 600 for synthesizing an instance of a component defined by a logical model according to one embodiment of the invention. The method 600 begins at step 602 and continues to step 604 where a loop is initiated. The loop beginning at step 604 examines each layer of the model by entering into another loop at step 606 which examines each component in a layer. For each component in a layer, the value of a flag is tested to see if the value specifies the CPU method of synthesis (step 608 ). If the flag value does specify CPU synthesis, the component is synthesized using the CPU method at step 610 and the flag value is propagated to the sub-components of the component at step 612.

However, if the flag for the component does not specify the CPU method for synthesis at step 608, then the flag is examined at step 620 to determine if it specifies the GPU method of synthesis. If the flag specifies the GPU method of synthesis, the component is synthesized using the GPU code for the component (step 622 ) and the flag is propagated to the subcomponents of the component at step 624. If the flag does not specify the GPU method for synthesis at step 620, then the default method of synthesis is used at step 630 and the default flag value is propagated to the subcomponents of the component at step 632.

After the component has been synthesized, the loop beginning at step 606 is continued at step 614 while components remain to be synthesized. Once each of the components in a layer have been synthesized, the loop beginning at step 606 continues at step 616 to synthesize the other layers while other layers remain to be synthesized. After all of the components and layers have been synthesized, the method 600 finishes at step 640.

While the foregoing is directed to embodiments of the present invention, other and further embodiments of the invention may be devised without departing from the basic scope thereof, and the scope thereof is determined by the claims that follow.

What is claimed is:

1. A method for creating multiple instances of a component wherein a specific design methodology used for each instance is different, comprising:
providing a logical model for the component, the logical model having a flag having two or more possible values; and
specifying, for each value of the flag, one or more blocks of hardware design code defining an instance of the component in accordance with a corresponding design methodology.

2. The method of claim 1, wherein one of the corresponding design methodologies is a structural design methodology.

3. The method of claim 2, wherein the structural design methodology comprises providing hardware design code for the component which uses one or more physical descriptions of subcomponents contained in a hardware library to define the instance of the component.

4. The method of claim 1, wherein the corresponding design methodology is a behavioral design methodology.

5. The method of claim 1, wherein:
a first value of the flag is used to select a first block of hardware design code corresponding to a first design methodology which uses a first one or more sets of parameter values; and
a second value of the flag is used to select a second block of hardware design code corresponding to a second design methodology which uses a second one or more sets of parameter values.

6. The method of claim 5, wherein:
the first design methodology corresponds to a first device which uses the first one or more sets of parameter values; and
the second design methodology corresponds to a second device which uses the second one or more sets of parameter values.

7. The method of claim 5, wherein each of the parameter values comprises at least one of a signal parameter, a clock polarity parameter, a library parameter, and a bus width parameter.

8. The method of claim 1, wherein one of the one or more blocks of hardware design code contains a block of hardware design code for testing a first device.

9. A method for creating multiple instances of a component from a single logical model comprising:
providing a flag in the logical model designating a design methodology for use in instantiating the component;
setting the flag to a first value to load a first block of hardware design code defining a first instance of the component wherein the first block of hardware design code corresponds to a first design methodology; and
setting the flag to a second value to load a second block of hardware design code defining a second instance of the component wherein the second block of hardware design code corresponds to a second design methodology.

10. The method of claim 9, wherein the first block of hardware design code corresponds to a structural design methodology.

11. The method of claim 9, wherein the second block of hardware design code corresponds to a behavioral design methodology.

12. The method of claim 9, further comprising:
creating the first instance of the component on a first device; and
creating the second instance of the component on a second device.

13. The method of claim 12, wherein the first device corresponds to a central processing unit and the second device corresponds to a graphical processing unit.

14. The method of claim 9, wherein the first value of the flag specifies a first set of parameters to use for a first device and the second value of the flag specifies a second set of parameters to use for a second device.

15. The method of claim 13, wherein the first set of parameters is different from the second set of parameters.

16. The method of claim 13, wherein the first set of parameters includes at least one of a bus width, a clock polarity, a signal, and a library.

17. The method of claim 9, wherein the first block of hardware design code contains a block of hardware design code for testing a first device.

18. A system for creating an instance of a component according to a specific design methodology, comprising:
a logical model for the component, the logical model having a flag having two or more possible values; and
a program configured to:
load the logical model;
determine a value of the flag; and
process, based on the value of the flag, one or more blocks of hardware design code defining the instance of the component in accordance with the specific design methodology.

19. The system of claim 18, wherein:
the corresponding design methodology is a structural design methodology; and
the structural design methodology comprises providing hardware design code for the component which uses one or more physical descriptions of subcomponents contained in a hardware library to define the instance of the component.

20. The system of claim 18, wherein:
the corresponding design methodology is a behavioral design methodology; and
the behavioral design methodology comprises providing a description of how a component functions in terms of one or more input signals and one or more output signals.

21. The system of claim 18, wherein the program comprises at least one of a synthesis tool and a compiler tool.

22. A computer readable medium, containing a program for processing multiple instances of a component wherein a specific design methodology used for each instance is different, wherein the program, when executed, performs operations comprising:
loading a logical model for the component, the logical model having a flag having two or more possible values;
determining a value of the flag; and
processing, based on the value of the flag, one or more blocks of hardware design code defining an instance of the component in accordance with a corresponding design methodology.

23. The computer readable medium of claim 22, wherein:
the corresponding design methodology is a structural design methodology; and
the structural design methodology comprises providing hardware design code for the component which uses one or more physical descriptions of subcomponents contained in a hardware library to define the instance of the component.

24. The computer readable medium of claim 22, wherein:
the corresponding design methodology is a behavioral design methodology; and
the behavioral design methodology comprises providing a description of how a component functions in terms of one or more input signals and one or more output signals.
